(19) United States
(12) Patent Application Publication
(10) Pub. No.: US 2026/0188826 A1
(43) Pub. Date: Jul. 2, 2026

(54) HOUSING OF BATTERY PACK AND BATTERY PACK

(71) Applicant: Kubota Corporation, Osaka (JP)

(72) Inventors: Shinji KISHI, Sakai-shi (JP); Ryota KIMURA, Sakai-shi (JP)

(21) Appl. No.: 19/546,793

(22) Filed: Feb. 23, 2026

Related U.S. Application Data
(63) Continuation of application No. PCT/JP2024/029483, filed on Aug. 20, 2024.

(30) Foreign Application Priority Data
Sep. 20, 2023 (JP) 2023-151962
Sep. 20, 2023 (JP) 2023-151964

(51) Int. Cl. H01M 50/289; B60L 50/64; H01M 10/42; H01M 50/204; H01M 50/249; H01M 50/271

(52) U.S. Cl. CPC H01M 50/289; H01M 10/425; H01M 50/204; H01M 50/249; H01M 50/271; B60L 50/64; H01M 2010/4271; H01M 2220/20

(57) ABSTRACT

A housing of a battery pack to be mounted on a hybrid system includes a housing main body including a first accommodating portion to accommodate a battery module to supply electricity to a motor generator of the hybrid system and a second accommodating portion to accommodate a control circuit of the battery module, a housing cover mounted on the housing main body, and a partition wall located between the first accommodating portion and the second accommodating portion in the housing main body to partition a space of the first accommodating portion and a space of the second accommodating portion from each other.

### CROSS REFERENCE TO RELATED APPLICATIONS

This application claims the benefit of priority to Japanese Patent Application Nos. 2023-151962 and 2023-151964 filed on Sep. 20, 2023 and is a Continuation Application of PCT Application No. PCT/JP2024/029483 filed on Aug. 20, 2024. The entire contents of each application are hereby incorporated herein by reference.

### BACKGROUND OF THE INVENTION

### 1. Field of the Invention

The present invention relates to housings of battery packs to be mounted on hybrid systems and battery packs.

### 2. Description of the Related Art

Japanese Patent Application Publication No. 2020-001451 discloses a battery mounting structure used for electric automobiles and a hybrid-type vehicles. This battery mounting structure includes a case in which a plurality of battery modules for driving a vehicle are accommodated on a lower side of a floor panel of a vehicle interior. The plurality of battery modules are divided into a lower-stage module and an upper-stage module, and the case has a lower-part case member made of metal, an intermediate-part case member made of metal, and an upper-part case member for covering a predetermined region of an upper-surface part of the intermediate-part case member from above. The lower-stage module is fixed to a bottom part of the lower-part case member, and the intermediate-part case member is fixed to the lower-part case member so as to cover the lower-stage module from above, and the lower-part module is accommodated in a water-tight manner. The upper-stage module is fixed in a state of close contact with the upper surface part of the intermediate-part case member in the predetermined area, the upper-part case member is formed in a container shape including an opening part in a bottom part, and in a state where the predetermined area is covered, and a peripheral part of the opening part is in a state of close contact with the upper-surface part of the intermediate-part case member, the upper-stage module is accommodated in a water-tight manner. Then, the lower-part case member is mounted on the lower side of the floor panel, whereby the case is fixed to the vehicle.

Japanese Patent Application Publication No. 2006-080042 discloses a battery pack device used for an electric automobile, for example, and constituted by batteries stacked in plural stages. This battery pack device includes a first battery group constituted by disposing a plurality of batteries on the same plane and a second battery group stacked on the first battery group with a battery tray between them and constituted by disposing a plurality of the same batteries as the batteries on the same plane in the battery tray, and includes a battery-pack main body including a battery part in which each battery is electrically connected to each other and a main body case accommodating the battery part. The battery has a cuboid shape and can be installed in a first attitude in which a height in a direction in which the second battery group is stacked on the first battery group is small and in a second attitude in which a position of a terminal is higher in the stacking direction than a position of a terminal of the battery in the first attitude. This battery-pack device is characterized in that, in the batteries of the first battery group, a first battery is disposed in the second attitude, a hole through which a terminal of the first battery protrudes to the second battery group side by passing through the vicinity of the terminal of the first battery is formed in the battery tray, in the batteries of the second battery group, the second battery in the vicinity of the hole is disposed in the first attitude, and the first battery and the second battery are electrically connected to each other by a connecting member whose shape is fixed.

In the housing of the battery pack, a large number of battery cells are accommodated. As this battery cell, a lithium-ion battery or a nickel-hydrogen battery is used. In the battery cell, a valve (safety valve) for releasing a gas when an internal pressure becomes high is provided. Since the housing of the battery pack is water-tight, when an abnormality occurs in the battery cell in the housing, the valve of the cell is operated, and the gas is released and then, an internal pressure of the housing rapidly rises. In the housing, other than the battery cell, a control circuit and components such as a wiring, connectors and the like, are accommodated, and it is desired that an influence on these components by the internal-pressure rise of the housing is reduced or prevented.

In addition, in the housing of the battery pack, battery cells in the number required for obtaining a desired voltage are accommodated. As this battery cell, a lithium-ion battery or a nickel-hydrogen battery is used. The battery cell is has a substantially cuboid shape, and a plurality of the battery cells are disposed in a limited space in the housing. Since the battery cell generates a heat by a chemical reaction of charging/discharging, it is important to efficiently release the heat emitted from the battery cell accommodated in the state of close contact in the housing to the outside.

### SUMMARY OF THE INVENTION

Example embodiments of the present invention provide housings of battery packs and battery packs that each reduce or prevent an influence on a component in a housing even when an internal-pressure rise occurs in the housing. In addition, battery packs each efficiently release a heat of a battery cell to an outside.

A first example embodiment of the present invention is a housing of a battery pack to be mounted on a hybrid system and is a housing of a battery pack including a housing main body including a first accommodating portion to accommodate a battery module to supply electricity to a motor generator of the hybrid system and a second accommodating portion to accommodate a control circuit of the battery module, a housing cover mounted on the housing main body, and a partition wall located between the first accommodating portion and the second accommodating portion in the housing main body to partition a space of the first accommodating portion to accommodate a battery module and a space of the second accommodating portion from each other.

A second example embodiment of the present invention is a battery pack to be mounted on a hybrid system and including a battery module to supply electricity to a motor generator of the hybrid system, a control circuit to control the battery module, and a housing to accommodate the battery module and the control circuit, in which the housing includes a housing main body including a first accommodating portion to accommodate the battery module and a second accommodating portion to accommodate the control circuit, a housing cover mounted on the housing main body, a partition wall provided between the first accommodating portion and the second accommodating portion of the housing main body, and the control circuit includes a BMU (Battery Management Unit) configured or programmed to control a voltage of the entire battery module.

A third example embodiment of the present invention is a battery pack to be mounted on a hybrid system and including a battery module to supply electricity to a motor generator of the hybrid system, a control circuit to control the battery module, a housing to accommodate the battery module and the control circuit, and a heat conductor between each of the battery module and the housing and including insulation.

According to example embodiments of the present invention, even when the internal-pressure rise occurs in the housing, housings of battery packs and battery packs reduce or prevent an influence on a component in the housing. In addition, according to example embodiments of the present invention, battery packs each efficiently release a heat of a battery cell to an outside.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram illustrating a hybrid system.

FIG. 2 is an appearance perspective view exemplifying a battery pack according to an example embodiment of the present invention.

FIG. 3 is a partial exploded perspective view exemplifying a battery pack according to an example embodiment of the present invention.

FIG. 4 is an appearance perspective view exemplifying a housing main body of a housing according to an example embodiment of the present invention.

FIG. 5 is an appearance perspective view exemplifying a battery pack including a housing according to an example embodiment of the present invention.

FIG. 6 is a schematic sectional view exemplifying a battery pack including a housing according to an example embodiment of the present invention.

FIG. 7 is an enlarged schematic sectional view of a periphery of a partition wall illustrated in FIG. 6.

FIG. 8 is a partial perspective view exemplifying a configuration of a periphery of the partition wall.

FIG. 9 is a block diagram illustrating a hybrid system according to another example embodiment of the present invention.

FIG. 10 is an appearance perspective view exemplifying another battery pack according to an example embodiment of the present invention.

FIG. 11 is a partial exploded perspective view exemplifying another battery pack according to an example embodiment.

FIG. 12 is a schematic sectional diagram exemplifying another battery pack according to an example embodiment of the present invention.

FIG. 13 is a perspective view exemplifying a ceiling surface of a housing cover.

### DETAILED DESCRIPTION OF THE EXAMPLE EMBODIMENTS

Hereinafter, example embodiments of the present invention will be explained with reference to the drawings.

It is to be noted that, the example embodiments which will be explained below are specific examples of the present invention and thus, various technically preferable limitations are given, but a range of the present invention is not limited to these example embodiments unless there is a description to the effect that the present invention is particularly limited in the following explanation. In addition, the same signs are given to the similar elements, components, features, portions, etc., and detailed explanation will be omitted as appropriate.

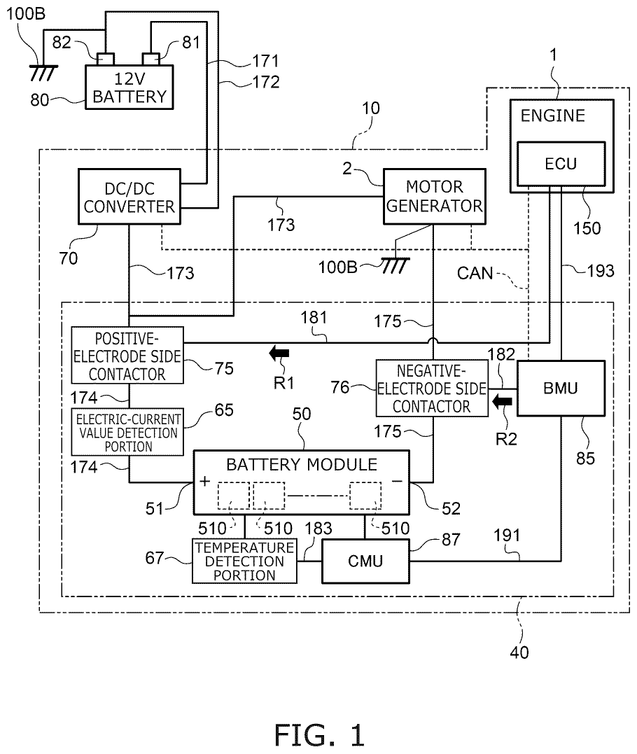

FIG. 1 is a block diagram illustrating a hybrid system.

A battery pack 40 to which a housing according to the present example embodiment is applied is mounted on a hybrid system 10 shown in FIG. 1. The hybrid system 10 includes an engine 1, a motor generator 2, and the battery pack 40. The hybrid system 10 according to the present example embodiment further includes a DC/DC converter 70. The engine 1 is an internal combustion engine and is a diesel engine, for example. The engine 1 is mounted on a vehicle (a passenger car, a small-sized moving body and the like), for example, and industrial machines such as a construction machine, an agricultural machine and the like.

The engine 1 is a supercharging high-output multi-cylinder diesel engine such as a 3-cylinder engine, a 4-cylinder engine and the like, for example. However, the engine 1 is not limited to a diesel engine. The engine 1 has an ECU (Engine Control Unit) 150. The ECU 150 is configured or programmed to control an operation of the engine 1 and control the motor generator 2 and the DC/DC converter 70 by communicating with the motor generator 2 and the DC/DC converter 70 via a CAN (Controller Area Network), for example.

The motor generator 2 is operated by electricity supplied from the battery pack 40 and supports the engine 1 when power is required when starting or accelerating a vehicle or the like on which the hybrid system 10 is mounted. In addition, the motor generator 2 converts kinetic energy of an industrial machine or the like on which the hybrid system 10 is mounted to electric energy and generates electricity.

The battery pack 40 includes a battery module 50, a positive-electrode side contactor 75, a negative-electrode side contactor 76, an electric-current value detection portion 65, a temperature detection portion 67, a BMU (Battery Management Unit) 85, and a CMU (Cell Management Unit) 87. The battery module 50 is provided as a driving power-supply of the motor generator 2 and supplies electricity to the motor generator 2. The battery module 50 includes at least one battery cell 510. In the hybrid system 10 shown in FIG. 1, such a number of battery cells 510 that is needed to obtain a voltage of 48V, for example, are included in the battery module 50. As the battery cell 510, a lithium-ion battery (LiB), for example, is cited. However, the battery cell 510 in the present example embodiment is not necessarily limited to a lithium-ion battery. The battery module 50 includes a positive-electrode (+) terminal 51 and a negative-electrode (−) terminal 52.

The positive-electrode side contactor 75 is provided in an electric circuit between the positive-electrode terminal 51 of the battery module 50 and the motor generator 2. Specifically, as shown in FIG. 1, the positive-electrode side contactor 75 is provided on positive-electrode wirings 173, 174 to connect the positive-electrode terminal 51 of the battery module 50 and the motor generator 2. That is, an electric circuit between the positive-electrode terminal 51 of the battery module 50 and the motor generator 2 includes the positive-electrode wiring 173 and the positive-electrode wiring 174. The positive-electrode side contactor 75 is electrically connected to the ECU 150 by a signal line 181 and opens/closes the positive-electrode wirings 173, 174 responsive to a control signal transmitted from the ECU 150 through the signal line 181.

It is to be noted that the positive-electrode side contactor 75 may be electrically connected to the BMU 85. In this case, the positive-electrode side contactor 75 opens/closes the positive-electrode wirings 173, 174 responsive to the control signal transmitted from the BMU 85. In the explanation of the present example embodiment, a case in which the positive-electrode side contactor 75 is electrically connected to the ECU 150 by the signal line 181 will be cited as an example.

The negative-electrode side contactor 76 is provided in an electric circuit between the negative-electrode terminal 52 of the battery module 50 and the motor generator 2. Specifically, as shown in FIG. 1, the negative-electrode side contactor 76 is provided on a negative-electrode wiring 175 which connects the negative-electrode terminal 52 of the battery module 50 and the motor generator 2. That is, the electric circuit between the negative-electrode terminal 52 of the battery module 50 and the motor generator 2 includes the negative-electrode wiring 175. The negative-electrode side contactor 76 is electrically connected to the BMU 85 by a signal line 182, and opens/closes the negative-electrode wiring 175 responsive to a control signal transmitted through the signal line 182 from the BMU 85.

It is to be noted that the negative-electrode side contactor 76 may be electrically connected to the ECU 150. In this case, the negative-electrode side contactor 76 performs opening/closing of the negative-electrode wiring 175 responsive to the control signal transmitted from the ECU 150. In the explanation of the present example embodiment, a case in which the negative-electrode side contactor 76 is electrically connected to the BMU 85 by the signal line 182 will be cited as an example.

The BMU 85 is an example of the “control circuit”. The BMU 85 is configured or programmed to control a voltage of the entire battery module 50. That is, the BMU 85 is electrically connected to the ECU 150 by a signal line 193 and is configured or programmed to control the negative-electrode side contactor 76 on the basis of a control signal transmitted through the signal line 193 from the ECU 150. The ECU 150 and the BMU 85 communicate with each other by CAN, for example, and monitor the other's state.

In addition, the BMU 85 monitors a state of the battery module 50 and can detect abnormality of the battery module 50. For example, the BMU 85 detects overcharge (minor failure) abnormality or overcharge (measure failure) abnormality on the basis of the voltage of the battery cell 510 obtained from the CMU 87. Alternatively, the BMU 85 detects overdischarge (minor failure) abnormality or over discharge (major failure) abnormality on the basis of a voltage of the battery cell 510 obtained from the CMU 87. Alternatively, the BMU 85 detects over-temperature (minor failure) abnormality on the basis of a temperature of the battery cell 510 obtained from the CMU 87. Alternatively, the BMU 85 detects over-current abnormality on the basis of an electric-current value obtained from the electric-current value detection portion 65 on the positive-electrode wiring 174.

The CMU 87 is an example of the “control circuit”. The CMU 87 monitors a state of the battery cell 510 included in the battery module 50 and sends information to the BMU 85. When a plurality of the battery cells 510 are included in the battery module 50, the CMU 87 monitors a voltage of each of the battery cells 510 and sends information related to the voltage of each of the battery cells 510 to the BMU 85 via a signal line 191. In addition, the CMU 87 obtains information on a temperature of the battery cell 510 detected by the temperature detection portion 67 through the signal line 183 and sends the information related to the temperature of the battery cell 510 to the BMU 85 via the signal line 191. The CMU 87 may be provided separately from the BMU 85 or may be provided integrally with the BMU 85.

As described above, the negative-electrode wiring 175 electrically connects the negative-electrode terminal 52 of the battery module 50 and the motor generator 2 and becomes a gland 100B. For example, the negative-electrode wiring 175 is connected to a body of a vehicle or the like on which the hybrid system 10 is mounted and is grounded. The positive-electrode wiring 173 electrically connects the positive-electrode terminal 51 of the battery module 50 and the motor generator 2 and electrically connects the motor generator 2 and the DC/DC converter 70. As the hybrid system 10 shown in FIG. 1, when the battery module 50 is a 48V lithium-ion battery, potentials of the positive-electrode wirings 173, 174 with respect to the negative-electrode wiring 175 is 48V.

The DC/DC converter 70 is electrically connected to a battery 80 via a positive-electrode wiring 171 and a negative-electrode wiring 172. As the battery 80, a 12V lead storage battery can be cited, as an example. The negative-electrode wiring 172 electrically connects a negative-electrode terminal 82 of the battery 80 and the DC/DC converter 70 and becomes a gland 100B. For example, the negative-electrode wiring 172 is connected to a body of a vehicle or the like on which the hybrid system 10 is mounted and is grounded. The positive-electrode wiring 171 electrically connects a positive-electrode terminal 81 of the battery 80 and the DC/DC converter 70. As in the hybrid system 10 shown in FIG. 1, when the battery 80 is a 12V lead storage battery, a potential of the positive-electrode wiring 171 with respect to the negative-electrode wiring 172 is 12V.

As described above, the motor generator 2 converts kinetic energy of a vehicle or the like on which the hybrid system 10 is mounted to electric energy and generates electricity by using a regenerative energy or the like. And the motor generator 2 supplies a voltage to the battery module 50 so as to charge the battery module 50 and supplies a voltage to the battery 80 so as to charge the battery 80. Here, when the hybrid system 10 shown in FIG. 1 is cited as an example, a potential of the positive-electrode wiring 173 with respect to the negative-electrode wiring 175 is 48V. That is, a power-generation potential of the motor generator 2 is 48V. On the other hand, a potential of the positive-electrode wiring 171 with respect to the negative-electrode wiring 172 is 12V. Thus, the DC/DC converter 70 converts the voltage of 48V generated by the motor generator 2 to a voltage of 12V. As a result, the motor generator 2 can supply the voltage of 12V to the battery 80 via the DC/DC converter 70 and charge the battery 80.

In addition, the DC/DC converter 70 is electrically connected to the battery module 50 and the battery 80 and can perform charging and discharging between the battery module 50 and the battery 80 on the basis of a control signal transmitted from the ECU 150. For example, the DC/DC converter 70 can perform discharging of the battery module 50 and charging of the battery 80 by converting the voltage and by causing a constant electric-current (10A, for example) to flow from the battery 80 toward the battery module 50. Alternatively, the DC/DC converter 70 can perform discharging of the battery 80 and charging of the battery module 50 by converting the voltage and by causing a constant electric-current (10A, for example) to flow from the battery 80 toward the battery module 50, for example.

The hybrid system 10 according to the present example embodiment has a function of capable of safely shutting down an electric circuit which supplies electricity from the battery module 50 to the motor generator 2, when an abnormality occurs in the battery module 50 or the entire hybrid system 10 is shut down.

When an ignition switch is turned on, for example, the ECU 150 electrically connects the positive-electrode wiring 174 by executing control of transmitting a control signal to the positive-electrode side contactor 75 via the signal line 181 and closing the positive-electrode side contactor 75. In addition, the BMU 85 electrically connects the negative-electrode wiring 175 by executing control of closing the negative-electrode side contactor 76 responsive to the control signal transmitted from the ECU 150 via the signal line 193. As a result, the battery module 50 can supply electricity to the motor generator 2.

On the other hand, when the ignition switch is turned off, for example, the ECU 150 electrically shuts down the positive-electrode wiring 174 by executing control of transmitting a control signal to the positive-electrode side contactor 75 through the signal line 181 and opening the positive-electrode side contactor 75. In addition, the BMU 85 electrically shuts down the negative-electrode wiring 175 by executing control of opening the negative-electrode side contactor 76 responsive to the control signal transmitted from the ECU 150 via the signal line 193. As a result, the supply of electricity from the battery module 50 to the motor generator 2 is stopped.

In addition, when the BMU 85 detects an abnormality of the battery module 50, for example, the ECU 150 electrically shuts down the positive-electrode wiring 174 by executing control of transmitting a first shut-down signal R1 to the positive-electrode side contactor 75 via the signal line 181 and opening the positive-electrode side contactor 75. In addition, the BMU 85 electrically shuts down the negative-electrode wiring 175 by executing control of transmitting a second shut-down signal R2 to the negative-electrode side contactor 76 via the signal line 182 singularly and not depending on a control signal transmitted from the ECU 150 and opening the negative-electrode side contactor 76.

Alternatively, as described above, the ECU 150 and the BMU 85 communicate with each other and monitors the other's state. Thus, when the ECU 150 detects abnormality of the BMU 85, the ECU 150 electrically shuts down the positive-electrode wiring 174 by executing control of transmitting the first shut-down signal R1 to the positive-electrode side contactor 75 by the signal line 181 and opening the positive-electrode side contactor 75. On the other hand, when the BMU 85 detects abnormality of the ECU 150, the BMU 85 electrically shuts down the negative-electrode wiring 175 by executing control of transmitting the second shut-down signal R2 to the negative-electrode side contactor 76 via the signal line 182 singularly and not depending on a control signal transmitted from the ECU 150 and opening the negative-electrode side contactor 76.

According to the above-described hybrid system 10, two contactors (in the present example embodiment, the positive-electrode side contactor 75 and the negative-electrode side contactor 76) are provided in the electric circuit which supplies electricity from the battery module 50 to the motor generator 2 (in the present example embodiment, the positive-electrode wirings 173, 174 and the negative-electrode wiring 175), and the ECU 150 controls the positive-electrode side contactor 75, while the BMU 85 controls the negative-electrode side contactor 76. Thus, even when an abnormality occurs in the battery module 50 or when an abnormality occurs in either one of the ECU 150 and the BMU 85, the hybrid system 10 according to the present example embodiment can shut down the electric circuit which supplies electricity from the battery module 50 to the motor generator 2. As a result, the hybrid system 10 can improve the safety related to the battery module 50 which supplies electricity to the motor generator 2.

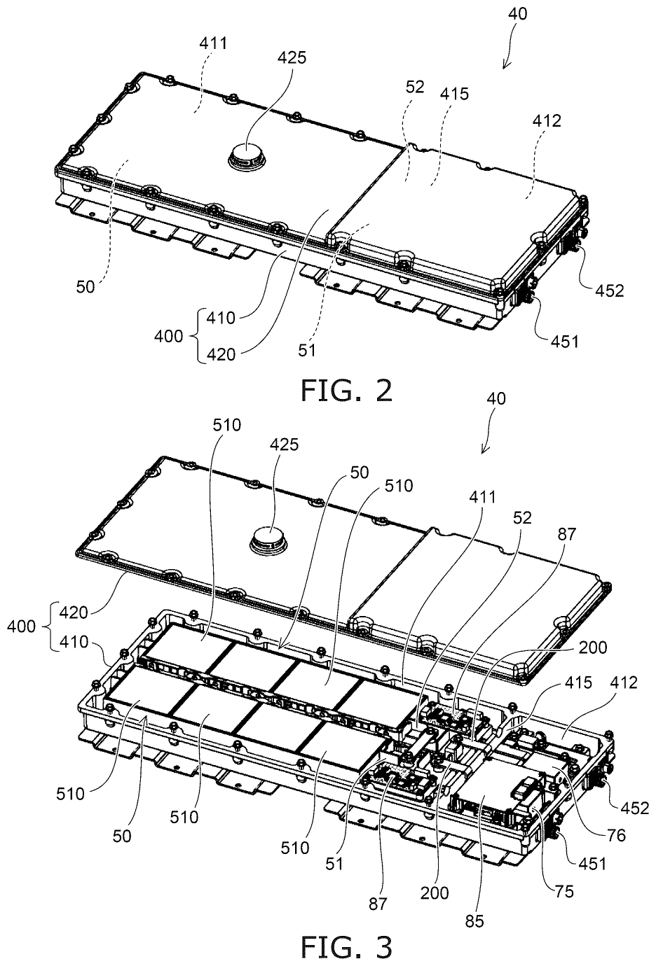

FIG. 2 is an appearance perspective view exemplifying a battery pack according to the present example embodiment.

FIG. 3 is a partial exploded perspective view exemplifying a battery pack according to the present example embodiment.

In FIG. 3, a state in which a housing cover 420 in a housing 400 of the battery pack 40 is open is shown.

The battery pack 40 includes the housing 400 to accommodate the battery module 50 and the BMU 85, which is a control circuit. The housing 400 includes a housing main body 410 and the housing cover 420. The housing main body 410 and the housing cover 420 are formed by casting using a metal material including aluminum, for example. On a joint between the housing main body 410 and the housing cover 420, a seal (not shown) is provided, and by covering the housing main body 410 with the housing cover 420 and by fastening and fixing them with a screw, for example, an inside of the housing 400 is brought into a water-tight state. On a side surface of the housing main body 410, external terminals 451, 452 are provided. The external terminals 451, 452 are terminals which output electricity of the battery pack 40 or a predetermined signal to an outside and inputs a signal from the ECU 150 or the like into the battery pack 40. When the external terminals 451, 452 are provided so as to protrude from a side surface of the housing main body 410 to the side (in a longitudinal direction, for example), it contributes to thinning of the battery pack 40.

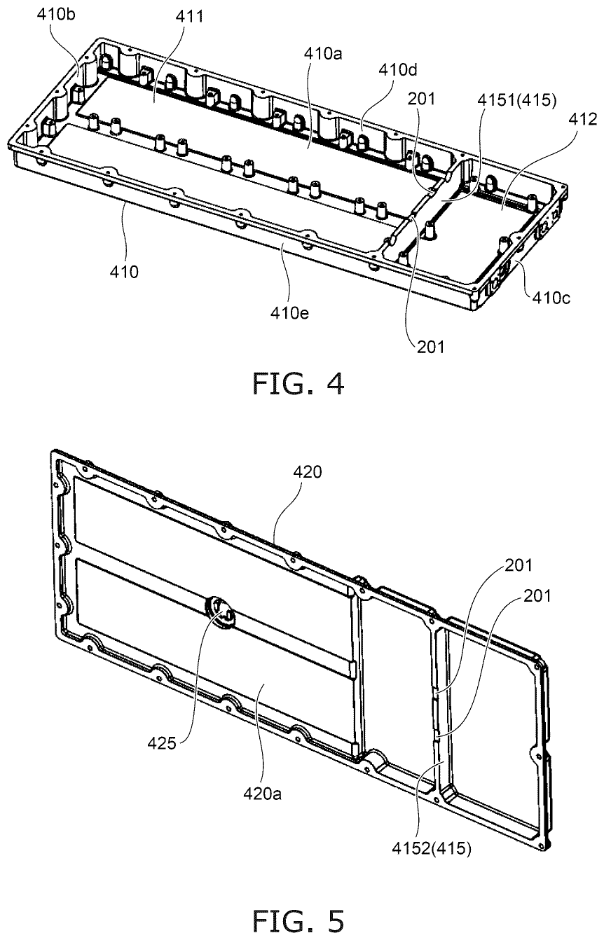

The housing main body 410 includes a first accommodating portion 411 to accommodate the battery module 50 and a second accommodating portion 412 to accommodate the BMU 85, which is an example of a control circuit. In the housing main body 410, a partition wall 415 is provided between the first accommodating portion 411 and the second accommodating portion 412. That is, one side with the partition wall 415 as a boundary is the first accommodating portion 411, while the other side is the second accommodating portion 412. The first accommodating portion 411 accommodates the battery module 50, and the second accommodating portion 412 accommodates the BMU 85, whereby, in the housing 400, the battery module 50 and the BMU 85 are divided by the partition wall 415. The first accommodating portion 411 is preferably larger than the second accommodating portion 412. Specifically, a distance from a side wall 410b (see FIG. 4) of the housing main body 140 to the partition wall 415 is longer than a distance from a side wall 410c (see FIG. 4) of the housing main body 410 to the partition wall 415. As a result, more battery cells 510 can be accommodated in the first accommodating portion 411.

As a result of the division by the partition wall 415, even if an internal pressure rises in the first accommodating portion 411, its influence can be reduced or prevented by the partition wall 415 so as not to extend to the second accommodating portion 412. For example, a valve (safety valve) to release a gas inside is provided on the battery cell 510 included in the battery module 50. When a gas is generated inside of the battery cell 510 due to abnormality such as overcharge, internal short-circuit or the like of the battery cell 510, and a pressure inside exceeds a predetermined value, for example, this valve is opened so as to release the gas. When the valve of the battery cell 510 is operated, the gas inside the battery cell 510 is released to the outside and is released into the housing 400. Since the housing 400 is water-tight, the internal pressure of the housing 400 rapidly rises due to the release of the gas from the battery cell 510. Since a large number of wirings with narrow pitches and thin lines and connector terminals are provided in the control circuit such as the BMU 85, resistance against deformation or damage is not high. Therefore, when the internal pressure of the housing 400 is transmitted to the control circuit via the gas release from the battery cell 510, there is a possibility that the wiring of the control circuit or the terminal of the connector is deformed or damaged.

As in the present example embodiment, since the housing 400 includes the partition wall 415 provided between the first accommodating portion 411 to accommodate the battery module 50 and the second accommodating portion 412 to accommodate the control circuit, even when the internal pressure of the first accommodating portion 411 rapidly rises due to the gas release from the battery cell 510, transmission of the pressure to the second accommodating portion 412 can be reduced or prevented by the partition wall 415, and the control circuit accommodated in the second accommodating portion 412 can be protected from the pressure more easily.

In the second accommodating portion 412 divided from the first accommodating portion 411 by the partition wall 415, the positive-electrode side contactor 75 or the negative-electrode side contactor 76 may be accommodated other than the control circuit. In addition, in the second accommodating portion 412, the CMU 87, which is an example of the control circuit, may be accommodated. As a result, other than the control circuit, transmission of an influence of the internal-pressure rise in the first accommodating portion 411 to the positive-electrode side contactor 75 and the negative-electrode side contactor 76 can be avoided, too. That is, such a configuration is preferable that the circuit or connector susceptible to an influence of a pressure is accommodated in the second accommodating portion 412. Particularly, it may be configured so that the battery cell 510 is disposed in the first accommodating portion 411, and all the electronic components other than the battery cell 510 are disposed in the second accommodating portion 412 so that the electronic components are effectively protected.

In addition, the number of the partition walls 415 is not limited to one, but the housing 400 may include a plurality of the partition walls 415. When the plurality of partition walls 415 are provided, a division in which the battery module 50 is accommodated is the first accommodating portion 411, and a division in which the battery module 50 is not accommodated is the second accommodating portion 412.

The partition wall 415 may be provided so as to surround the control circuit in the housing 400 or may be provided over the whole area between the two side walls facing each other of the housing main body 410. When the partition wall 415 is provided so as to surround the control circuit, the control circuit can be surrounded in a relatively small area and becomes unsusceptible to a pressure change on an outer side of the partition wall 415. In addition, when the partition wall 415 is provided on the whole area between the two side walls facing each other of the housing main body 410, the first accommodating portion 411 and the second accommodating portion 412 can be easily divided by the partition wall 415, the partition wall 415 plays a role of a beam which connects the two side walls to each other, and strength of the housing 400 is increased.

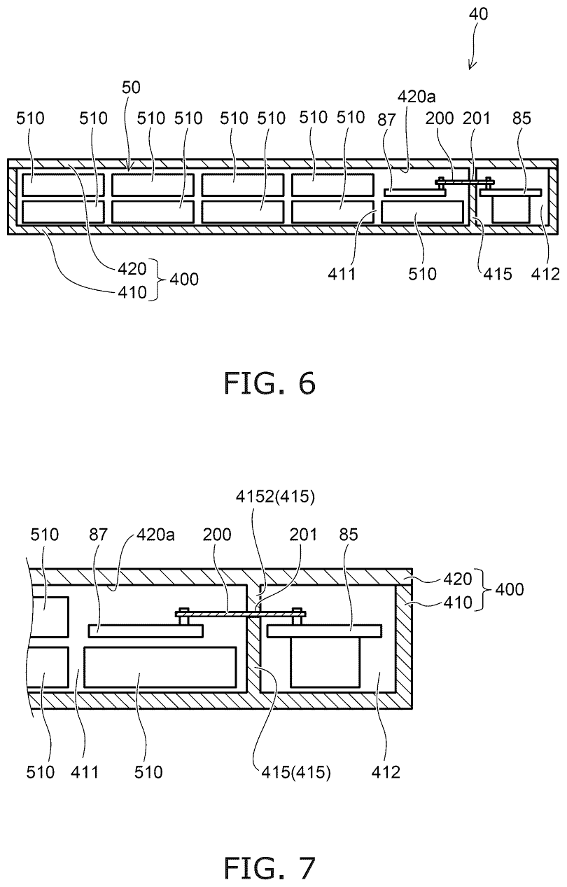

The partition wall 415 is preferably provided from a bottom surface of the housing main body 410 to reach a ceiling surface 420a of the housing cover 420 (see FIG. 5 and FIG. 6). As a result, transmission of a pressure from the first accommodating portion 411 to the second accommodating portion 412 is effectively reduced or prevented.

FIG. 4 is an appearance perspective view exemplifying a housing main body of a housing according to the present example embodiment.

FIG. 5 is an appearance perspective view exemplifying a housing cover of the housing according to the present example embodiment.

FIG. 5 illustrates an appearance perspective view when viewed from the ceiling surface 420a side of the housing cover 420.

As shown in FIG. 4, the housing main body 410 has a dish shape, for example. The housing main body 410 includes a bottom surface 410a and four side walls 410b to 410e provided around the bottom surface 410a. In the four side walls 410b to 410e, a main body side partition wall 4151 in the partition wall 415 is provided so as to go across a space between the two side walls 410d, 410e facing each other.

On the other hand, as shown in FIG. 5, on the ceiling surface 420a of the housing cover 420, a cover side partition wall 4152 in the partition wall 415 is provided. The cover side partition wall 4152 is provided at a position of the ceiling surface 420a facing the main body side partition wall 4151, when the housing cover 420 covers the housing main body 410. As a result, when the housing cover 420 is mounted on the housing main body 410, the main body side partition wall 4151 and the cover side partition wall 4152 face each other and overlap, and one partition wall 415 is provided.

The housing cover 420 may include a vent valve 425 which is opened when the internal pressure of the first accommodating portion 411 of the housing 400 reaches a predetermined pressure. The vent valve 425 is preferably provided so as to be operated when a gas is released even from any one of the battery cells 510 included in the battery module 50. As a result, a rise of the internal pressure which does not occur in the first accommodating portion 411 can be released as soon as possible so as not to influence the control circuit of the second accommodating portion 412.

FIG. 6 is a schematic sectional diagram exemplifying the battery pack using the housing according to the present example embodiment.

FIG. 7 is an enlarged schematic sectional diagram of a periphery of the partition wall shown in FIG. 6.

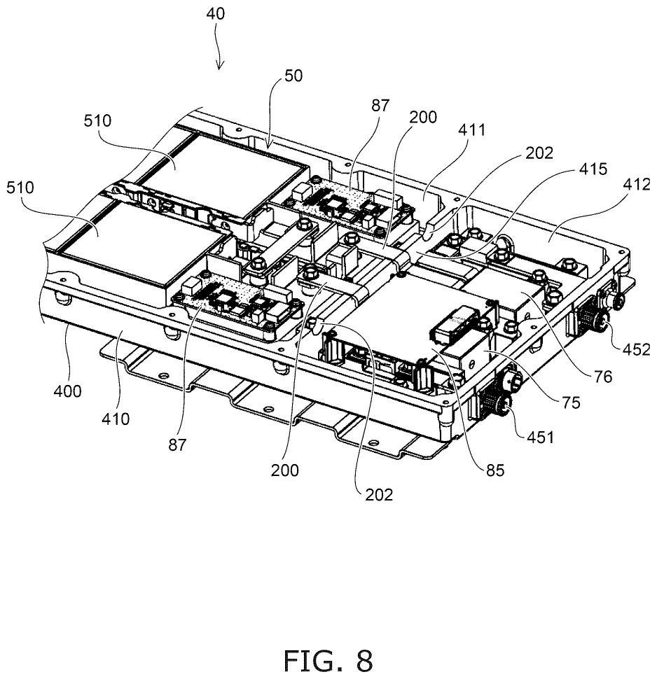

FIG. 8 is a partial perspective view exemplifying a configuration around the partition wall.

In the first accommodating portion 411 of the housing main body 410, the battery module 50 is accommodated, and in the second accommodating portion 412, the BMU 85, which is a control circuit, is accommodated. Between the battery module 50 and the BMU 85, a bus bar 200, which is a conductor to cause the both to be electrically conducted, is provided. The bus bar 200 includes a metal (copper, for example) plate material in a predetermined shape. In the present example embodiment, since there is the partition wall 415 between the first accommodating portion 411 and the second accommodating portion 412, the bus bar 200 is provided between the first accommodating portion 411 and the second accommodating portion 412 so as to cross the partition wall 415. It is to be noted that, in the present example embodiment, the case of using the bus bar 200 is an example, but a conductor other than the bus bar 200 may be applied.

For example, at each of the positions where the bus bar 200 of the main body side partition wall 4151 crosses and a position where the bus bar 200 of the cover side partition wall 4152 crosses, a recess 201 is provided, and when the main body side partition wall 4151 and the cover side partition wall 4152 are caused to face and overlap each other, the recesses 201 define holes provided in the partition wall 415. The hole corresponds to a sectional shape of the bus bar 200. When the bus bar 200 extends through this hole, the bus bar 200 crosses the partition wall 415. When the housing cover 420 is mounted on the housing main body 410, this hole is blocked by the bus bar 200. As a result, even when the hole by the recess 201 is located in the partition wall 415, a path of pressure leakage between the first accommodating portion 411 and the second accommodating portion 412 is effectively shut off. It is to be noted that a surface of the bus bar 200 is covered with an insulator (not shown), and the partition wall 415 and the bus bar 200 are not conducted with each other. A structure with high sealing performance (liquid-state gasket or the like) may be interposed between the bus bar 200 and the partition wall 415.

In addition, when it is necessary to pass a wiring other than the bus bar 200 (a wiring for sending a signal for a temperature sensor provided in the battery module 50 or voltage detection to the BMU 85, for example) between the first accommodating portion 411 and the second accommodating portion 412, a recess 202 (see FIG. 8) may be provided in the partition wall 415. When the main body side partition wall 4151 and the cover side partition wall 4152 are faced and made to overlap each other, the recess 202 becomes a through hole provided in the partition wall 415. The wiring is passed between the first accommodating portion 411 and the second accommodating portion 412 through this through hole. It is to be noted that a seal material is preferably provided between the through hole and the wiring. As a result, pressure leakage in the through hole of the partition wall 415 is reduced or prevented.

According to the present example embodiment, even when an internal-pressure rise occurs in the housing 400, the housing 400 of the battery pack 40 and the battery pack 40 which can reduce or prevent an influence on components in the housing 400 can be provided.

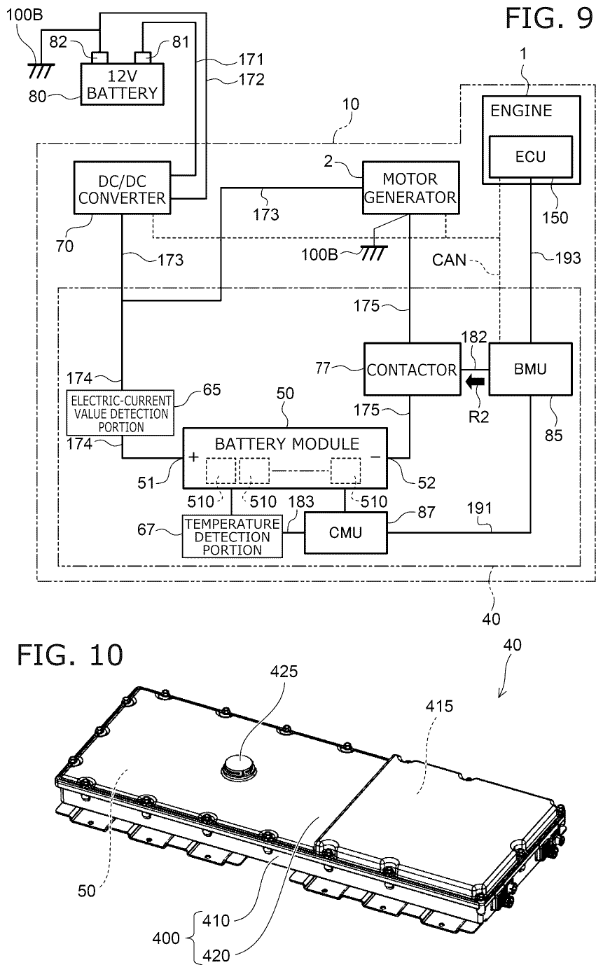

FIG. 9 is a block diagram illustrating a hybrid system according to another example embodiment.

As shown in FIG. 9, the hybrid system 10 may include one contactor 77. The contactor 77 is provided between the battery module 50 and the BMU 85. In the example shown in FIG. 9, the contactor 77 is provided between the negative-electrode terminal 52 of the battery module 50 and the BMU 85, but the contactor 77 may be provided between the positive-electrode terminal 51 of the battery module 50 and the BMU 85.

When the BMU 85 detects abnormality of the battery module 50, the second shut-down signal R2 is transmitted from the BMU 85 to the contactor 77, and control to open the contactor 77 is executed. As a result, the negative-electrode wiring 175 is electrically shut down, and safety related to the battery module 50 is ensured.

Subsequently, another battery pack will be explained.

It is to be noted that, when elements of another battery pack 40 are similar to the elements of the battery pack 40 described above in relation with FIG. 2 to FIG. 8, duplicated explanation will be omitted as appropriate, and different points will be mainly explained below.

FIG. 10 is an appearance perspective view exemplifying another battery pack according to the present example embodiment.

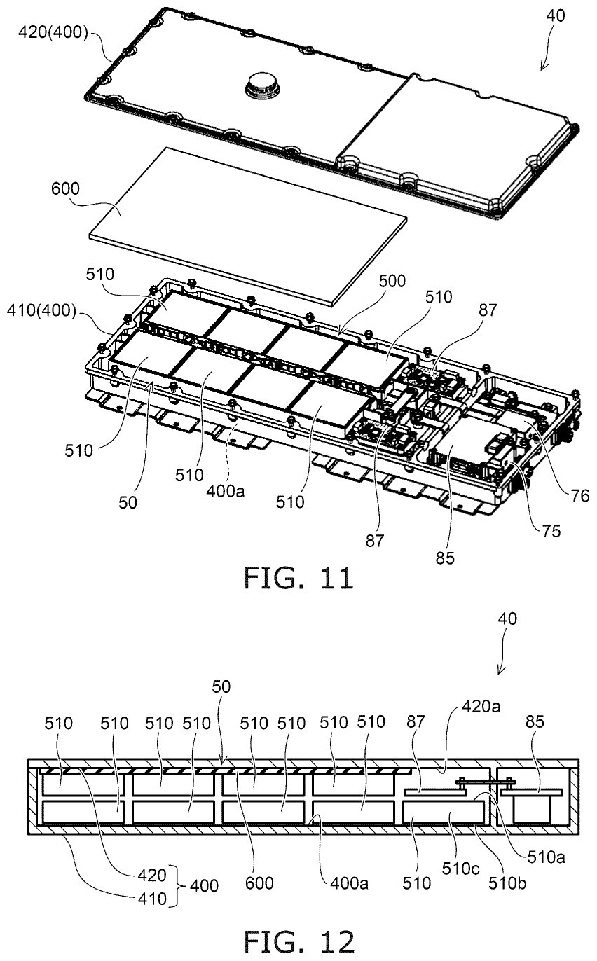

FIG. 11 is a partial exploded perspective view exemplifying another battery pack according to the present example embodiment.

In FIG. 11, a state in which the housing cover 420 in the housing 400 of the battery pack 40 and a heat conductor 600 are open is illustrated.

FIG. 12 is a schematic sectional diagram exemplifying another battery pack according to the present example embodiment.

The battery pack 40 includes the battery module 50, a control circuit including the BMU 85 and the CMU 87, and the housing 400 accommodating the battery module 50 and the control circuit. The housing main body 410 and the housing cover 420 are formed by casting using a metal material including aluminum, for example. On a joint between the housing main body 410 and the housing cover 420, a seal (not shown) is provided, and by covering the housing main body 410 with the housing cover 420 and by fastening and fixing them with a screw, for example, an inside of the housing 400 is brought into a water-tight state.

The battery module 50 accommodated in the housing 400 includes a plurality of the battery cells 510, for example. In one unit of the housing 400, one unit of the battery module 50 may be accommodated or a plurality of the battery modules 50 may be accommodated.

The battery cell 510 is provided in a substantially cuboid shape including planar portions facing each other (an upper surface portion 510a and a bottom surface portion 510b), and four side surface portions 510c including an area smaller than those of the upper surface portion 510a and the bottom surface portion 510b. And the battery cells 510 are disposed in parallel or substantially in parallel along the bottom surface 400a such that the bottom surface portion 510b faces the bottom surface 400a of the housing 400.

The battery module 50 may include a plurality of the battery cells 510. In this case, the plurality of battery cells 510 are preferably disposed in parallel or substantially in parallel along the bottom surface 400a of the housing 400. In addition, the battery cell 510 may be disposed in one stage on the housing 400 or may be disposed in plural stages. In the case of the plural stages, it is preferable that the upper surface portion 510a and the bottom surface portion 510b of the two battery cells 510 in a stacking direction are disposed so as to face each other.

Between the battery module 50 accommodated in the housing 400 and the housing 400, the heat conductor 600 including insulation is provided. For the heat conductor 600, a material including insulation and heat conductivity such as a silicone sheet, for example, is used. The heat conductor 600 is disposed between the upper surface portion 510a of the battery cell 510 and the ceiling surface 420a of the housing cover 420 (housing 400) facing the bottom surface 400a of the housing 400. It is preferable that the heat conductor 600 is in contact with each of the upper surface portion 510a of the battery cell 510 and the ceiling surface 420a of the housing cover 420. It is to be noted that some structure may be interposed between the heat conductor 600 and the upper surface portion 510a and between the heat conductor 600 and the ceiling surface 420a.

Since the bottom surface portion 510b is disposed as the battery cell 510 so as to face the bottom surface 400a of the housing 400, the upper surface portion 510a of the battery cell 510 is faced with the ceiling surface 420a of the housing cover 420. In the battery cell 510, an area of the upper surface portion 510a is larger than an area of the side surface portion 510c and thus, by bringing the upper surface portion 510a into contact with the heat conductor 600 (including a case of contact via the member), a heat generated in the battery cell 510 can be effectively transmitted to the heat conductor 600. In addition, since the heat conductor 600 is brought into contact with the ceiling surface 420a of the housing cover 420 (including a case of contact via the member), the heat including been transmitted from the battery cell 510 to the heat conductor 600 is effectively transmitted to the housing cover 420 and can be easily released from the housing 400 to the outside easily.

The battery pack 40 may include a plurality of the battery modules 50. In this case, the plurality of battery modules 50 are preferably disposed in parallel or substantially in parallel along the bottom surface 400a of the housing 400. As a result, since the upper surface portions 510a of the battery cells 510 do not overlap in the plurality of battery modules 50, it is advantageous on a heat dissipation surface.

In such a configuration that the plurality of battery modules 50 are disposed in parallel or substantially in parallel, the heat conductor 600 may have a portion disposed between the adjacent battery modules 50 in the plurality of battery modules 50. By disposing a portion of the heat conductor 600 between the adjacent battery modules 50, a heat can be easily transmitted not only from the upper surface portion 510a of the battery cell 510 but also from a portion of the side surface portion 510c to the heat conductor 600.

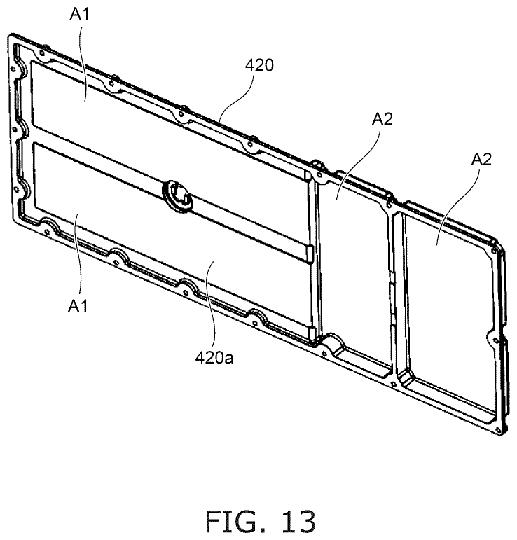

FIG. 13 is a perspective view exemplifying a ceiling surface of the housing cover.

The housing cover 420 is formed by casting by aluminum, for example. The ceiling surface 420a of the housing cover 420 includes a first area A1 facing the battery module 50 (see FIG. 11) and a second area A2 other than that. In the housing cover 420, a surface roughness of the first area A1 is preferably set lower than the surface roughness of the second area A2. For example, in a state in which the housing cover 420 is formed by casting, a surface of a mold by casting is transferred both to the first area A1 and the second area A2, and the surface roughness is relatively rough. Thus, by performing cutting or the like on the first area A1, machining is performed with the surface roughness of the first area A1 lower than that of the second area A2. As a result, a degree of close contact between the first area A1 in the ceiling surface 420a of the housing cover 420 and the heat conductor 600 is improved, and the heat can be transmitted from the heat conductor 600 to the housing cover 420 more effectively.

According to example embodiments described above, battery packs that can efficiently release a heat of the battery cell 510 to an outside are provided.

The example embodiments of the present invention have been explained as above. However, the present invention is not limited to the above-described example embodiments but is capable of various changes within a range not departing from the scope of claims. For example, the configuration of the above-described example embodiments may be partially omitted or arbitrarily combined differently from the above.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A housing of a battery pack to be mounted on a hybrid system, the housing of the battery pack comprising:
a housing main body including a first accommodating portion to accommodate a battery module to supply electricity to a motor generator of the hybrid system and a second accommodating portion to accommodate a control circuit of the battery module;
a housing cover mounted on the housing main body; and
a partition wall located between the first accommodating portion and the second accommodating portion in the housing main body to partition a space of the first accommodating portion and a space of the second accommodating portion from each other.

2. The housing of the battery pack according to claim 1, wherein the partition wall extends to a ceiling surface of the housing cover from a bottom surface of the housing main body.

3. The housing of the battery pack according to claim 1, wherein the partition wall extends across a whole area between two opposing side walls of the housing main body.

4. The housing of the battery pack according to claim 2, wherein the partition wall extends across a whole area between two opposing side walls of the housing main body.

5. The housing of the battery pack according to claim 3, wherein
the partition wall includes a main body side partition wall provided on a side of the housing main body and a cover side partition wall provided on a side of the housing cover; and
when the housing cover is mounted on the housing main body, the partition wall includes the main body side partition wall and the cover side partition wall facing each other.

6. The housing of the battery pack according to claim 4, wherein
the partition wall includes a main body side partition wall provided on a side of the housing main body and a cover side partition wall provided on a side of the housing cover; and
when the housing cover is mounted on the housing main body, the partition wall includes the main body side partition wall and the cover side partition wall facing each other.

7. The housing of the battery pack according to claim 3, wherein a vent valve in the housing cover is openable when an internal pressure of the first accommodating portion reaches a predetermined pressure.

8. The housing of the battery pack according to claim 4, wherein a vent valve in the housing cover is openable when an internal pressure of the first accommodating portion reaches a predetermined pressure.

9. The housing of the battery pack according to claim 1, wherein
the housing main body has a dish shape;
the first accommodating portion and the second accommodating portion are parallel or substantially parallel to each other along a bottom surface of the housing main body; and
the housing cover covers the first accommodating portion and the second accommodating portion.

10. A battery pack comprising:
a housing of the battery pack to be mounted on a hybrid system, the housing of the battery pack including:
a housing main body including a first accommodating portion to accommodate a battery module to supply electricity to a motor generator of the hybrid system and a second accommodating portion to accommodate a control circuit of the battery module;
a housing cover mounted on the housing main body; and
a partition wall located between the first accommodating portion and the second accommodating portion in the housing main body to partition a space of the first accommodating portion and a space of the second accommodating portion from each other; and
the control circuit includes a Battery Management Unit configured or programmed to control an entire voltage of the battery module.

11. The battery pack according to claim 10, wherein the partition wall extends to a ceiling surface of the housing cover from a bottom surface of the housing main body.

12. The battery pack according to claim 10, wherein the partition wall extends across a whole area between two opposing side walls of the housing main body.

13. The battery pack according to claim 11, wherein the partition wall extends across a whole area between two opposing side walls of the housing main body.

14. The battery pack according to claim 12, wherein
the partition wall includes a main body side partition wall provided on a side of the housing main body and a cover side partition wall provided on a side of the housing cover; and
when the housing cover is mounted on the housing main body, the partition wall includes the main body side partition wall and the cover side partition wall facing each other.

15. The battery pack according to claim 13, wherein
the partition wall includes a main body side partition wall provided on a side of the housing main body and a cover side partition wall provided on a side of the housing cover; and
when the housing cover is mounted on the housing main body, the partition wall includes the main body side partition wall and the cover side partition wall facing each other.

16. The battery pack according to claim 12, wherein a vent valve in the housing cover is openable when an internal pressure of the first accommodating portion reaches a predetermined pressure.

17. The battery pack according to claim 13, wherein a vent valve in the housing cover is openable when an internal pressure of the first accommodating portion reaches a predetermined pressure.

18. The battery pack according to claim 10, wherein
the housing main body has a dish shape;
the first accommodating portion and the second accommodating portion are parallel or substantially parallel to each other along a bottom surface of the housing main body; and
the housing cover covers the first accommodating portion and the second accommodating portion.

19. The battery pack according to claim 10, further comprising:
a bus bar to cause the battery module and the control circuit to be conducted; wherein
the bus bar is located between the first accommodating portion and the second accommodating portion such that the bus bar crosses the partition wall.

20. The battery pack according to claim 10, further comprising a contactor to open or close a wiring between the battery module and the motor generator; wherein
the contactor is located in the second accommodating portion.
